(19) United States
(12) Patent Application Publication
(10) Pub. No.: US 2022/0379595 A1
(43) Pub. Date: Dec. 1, 2022

(54) ELASTIC FILM LAMINATES WITH FILM MADE IN A CALENDARING PROCESS

(71) Applicant: Avient Corporation, Avon Lake, OH (US)

(72) Inventors: Ketan SHAH, Gurnee, IL (US); Cesar CRUZ, Woodstock, IL (US)

(73) Assignee: Avient Corporation, Avon Lake, OH (US)

(21) Appl. No.: 17/772,413

(22) PCT Filed: Oct. 26, 2020
(86) PCT No.: PCT/US2020/057326

§ 371 Date: Apr. 27, 2022

Related U.S. Application Data
(60) Provisional application No. 62/926,533, filed on Oct. 27, 2019.

(51) Int. Cl. B32B 37/00; B32B 27/12; B32B 27/30

(52) U.S. Cl. CPC B32B 37/156; B32B 27/12; B32B 27/302; B32B 2250/03; B32B 2250/40; B32B 2262/0276; B32B 2262/062; B32B 2307/51; B32B 2307/748; B32B 2437/02; B32B 2451/00; B32B 2479/00

(57) ABSTRACT

Disclosed is a process for creating an elastic film or sheet by calendaring a composition, including a polymer and a fabric. The composition may include a polymer, a cotton, or a combination of both. The calendared composition can form tough, flexible films and sheets. The film and sheet can have optical and physical properties that make them suitable as a replacement for some PVC films. Also disclosed is a composition for calendaring including a fabric and a polymer.

### CLAIM OF PRIORITY

This application claims the benefit of U.S. Provisional Patent Application Ser. No. 62/926,533 bearing Attorney Docket Number 12019014 and filed on Oct. 27, 2019, which is hereby incorporated by reference in its entirety.

### FIELD OF THE INVENTION

This invention relates to elastic film laminates made in a calendaring process and capable of being calendared with a fabric layer.

### BACKGROUND OF THE INVENTION

Demand exists for a material that can replace the polyvinyl chloride containing fabric used in products such as drapery or fabric coverings for furniture.

### SUMMARY OF THE INVENTION

The present invention discloses a composition for calendaring, where the composition has a fabric and an elastic film component including a styrenic block copolymer, an oil, and optional additives. The elastic film is adjacent to the fabric during and after the calendaring process.

The styrenic block copolymer is may be styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, or combinations of two or more thereof.

The fabric of the composition may be cotton, polyester or combinations or two or more thereof.

In an embodiment, the invention is an article made from the calendared composition. The article may be apparel, footwear, furniture or furniture covering, drapery, or any other suitable object.

The invention also discloses a method for manufacturing the composition.

Features of the invention will become apparent with reference to the following embodiments. There exist various refinements of the features noted in relation to the above-mentioned aspects of the disclosed invention. Additional features may also be incorporated in the above-mentioned aspects of the disclosed invention. These refinements and additional features may exist individually or in any combination. For instance, various features discussed below in relation to any of the described aspects of the invention may be incorporated into any of the described aspects of the invention alone or in any combination.

### EMBODIMENTS OF THE INVENTION

The following methodology was invented to develop and screen materials that would make uniform film in the calendaring process with good melt strength and cohesive strength, and transfer on to fabric without cohesive failure onto the SS rolls.

First, uniform 10 mil films were made in a Brabender™ machine using film die. The film was then sandwiched between a stainless steel plate on one side, and polyester or cotton fabric on the other side, forming a layered assembly. Next, the layered assembly was then pre-heated to 300° F. in a compression molding machine for 60 seconds without adding any pressure, and subsequently pressed between the two plates by closing them under 25 PSI pressure for 15 seconds. This method was used replicate the calendaring process. In an embodiment, the film could be sandwiched between two fabric layers, i.e., fabric-film-fabric. In an embodiment, the composition could include a fabric with the film on one side or two sides. In an embodiment, the film could have fabric only on one side. In an embodiment, the invention could be made with standard calendaring process technology.

The assembly was then taken out and while hot, the fabric was pulled by hand to evaluate if the elastic film detached from the stainless steel plates without cohesive failure and stayed attached to the fabric, making a good laminate. If the film successfully stayed attached to the fabric without cohesive failure, it would mean that the formulation of the film would make a good laminate in the calendaring process. This type of experimentation represents a qualitative evaluation of the elastic film in regards to its bonding with fabric, which demonstrated sufficient cohesive strength to prevent ripping.

In order to quantify the above process, and be able to predict its performance in the calendaring process, the assembly was cooled to room temperature as it came out of the compression-molding machine, and then carried out 90-degree peel test in Instron™ machine. If the film peeled without cohesive failure from the stainless steel plate, remained attached to the fabric, and if the peel force was under 3 lbf at room temperature, the film material will detach from the stainless steel rolls in the calendaring process at 300-400° F., without cohesive failure and make a good laminate in the calendaring process. If however, the peel force was greater than 4 lbf at room temperature, it would indicate cohesive failure with poor melt strength. The range of peel force between 3 and 4 lbf appears to be a borderline case, where, depending on other criteria the film demonstrated good cohesive strength.

The melt index at 190° C. and 230° C. of the elastic formulations were measured to determine the physical properties of the assembly. If the melt index is below 4 grams/10 minutes at 190° C. and less than 35 grams/10 minutes at 230° C., the elastic formulation showed very good cohesive strength. If, on the other hand, the melt indices were greater than 5 grams/10 minutes at 190° C., and greater than 39 grams/10 minutes at 230° C., the elastic formulation showed poor melt strength and cohesive strength.

Once again, the melt index range between 4 and 5 grams/10 minutes at 190 C and between 35-39 grams/10 min at 230° C. appear to be borderline case. In summary, if the melt indices at 190° C. for the elastic film formulation was less than 4 grams/10 minutes at 190° C., and below 35 grams/10 minutes at 230° C., such a formulation would make a film that will demonstrate peel force from the stainless steel plate at room temperature to be below 3 lbf, and will remain bonded with the fabric.

If, on the other hand, if the melt indices at 190° C. for the elastic film formulation was greater than 5 grams/10 minutes at 190° C., and greater than 39 grams/10 minutes at 230° C., such formulations would make films that would demonstrate peel strength greater than 4 lbf, and will have poor cohesive strength. The range of melt index between 4-5 grams/10 min at 190° C., and between 35-39 grams/10 min at 230° C. appears to be a closer call by which the films made of such formulations will demonstrate peel force between 3-4 lbf, and will sometimes peel cleanly from the stainless steel rolls, and sometimes peel with cohesive failure.

If a film is made of the elastic formulation that meets the following criteria, the film will demonstrate clean peel from the stainless steel rolls at 300-400° F., and cleanly transfer onto the fabric without cohesive failure in the calendaring process: (1) melt index at 190° C. below 4 grams/10 min; (2) melt index at 230° C. below 35 grams/10 min; and (3) peel force from the stainless steel plates at room temperature to be between 0-3 lbf.

If a film is made of the elastic formulation that meets the following criteria, the film will demonstrate cohesive failure with the stainless steel rolls at 300-400° F., and unevenly transfer onto the fabric with cohesive failure and melt fracture in the calendaring process: (1) melt index at 190° C. greater than 5 grams/10 min; (2) melt index at 230° C. above 39 grams/10 min; and (3) peel force from the stainless steel plates at room temperature to be greater than 4 lbf.

If a film is made of the elastic formulation that meets the following criteria, the film will sometimes demonstrate clean peel from the stainless rolls at 300-400° F., and sometimes cleanly transfer onto the fabric without cohesive failure in the calendaring process: (1) melt index at 190° C. between 4-5 grams/10 min; (2) melt index at 230° C. between 35-39 grams/10 min; and (3) peel force from the SS plates at room temperature to be between 3-4 lbf.

The elastic film portion of the invention may include a polymer, an oil, and optional additives.

Suitable polymers includes thermoplastic elastomers other than thermoplastic polyurethanes, such as styrenic block copolymers, thermoplastic vulcanizates, polyolefin elastomers, copolyesters, and combinations thereof.

Non-limiting examples of suitable styrenic block copolymers include styrene-ethylene/butylene-styrene (SEB S), styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof.

Non-limiting examples of suitable copolymers include block copolymers composed from repeating soft segments of aliphatic polyether or aliphatic polyester and hard segments of aromatic polyester.

The polymer may be present in any appropriate amount, including, but not limited to approximately 25 wt. % to approximately 75 wt. %; approximately 30 wt. % to approximately 70 wt. %; approximately 35 wt. % to approximately 65 wt. %; approximately 40 wt. % to approximately 60 wt. %; and approximately 45 wt. % to approximately 55 wt. %.

Any suitable oil, e.g., mineral oil, vegetable oil, synthetic oil, may be used. Specific examples of oil components are detailed in the Examples section below.

The oil may be present in any appropriate amount, including, but not limited to approximately 20 wt. % to approximately 35 wt. %; approximately 25 wt. % to approximately 30 wt. %; and approximately 27 wt. % to approximately 29 wt. %.

Suitable optional additives include conventional or commercially available plastics additives. Those skilled in the art of thermoplastics compounding, without undue experimentation, can select suitable additives from available references, for example, E.W. Flick, “Plastics Additives Database,” Plastics Design Library (Elsevier 2004).

Optional additives can be used in any amount that is sufficient to obtain a desired processing or performance property for the elastic film portion of the composition and/or the article molded therefrom. The amount should not be wasteful of the additive nor detrimental to the processing or performance of the elastic film and/or the article molded therefrom.

Non-limiting examples of optional additives include adhesion promoters; anti-fogging agents; antioxidants; anti-static agents; biocides (antibacterials, fungicides, and mildewcides); colorants including pigments and dyes; dispersants; fillers and extenders; fire and flame retardants and smoke suppressants; hardness adjusters; impact modifiers; initiators; lubricants; micas; mold release agents; oils and plasticizers; processing aids; secondary polymers; silanes, titanates and zirconates; slip and anti-blocking agents; stabilizers; stearates; ultraviolet light absorbers; viscosity regulators; and waxes.

In some embodiments, the elastic film further include one or more of antioxidants and stabilizers; colorants; mold release agents; ultraviolet light absorbers; and combinations thereof.

Optional Plasticizer

Plasticizer can be used, for example, to adjust softness and/or improve flow or other properties of the polymer compound.

Any conventional oil capable of plasticizing styrenic block copolymer, such as mineral oil, vegetable oil, synthetic oil, etc., can be used in the present invention. Examples of commercially available oils include those available under the PURETOL 380 brand from Petro-Canada, and those available under the PRIMOL 382 brand from ExxonMobil.

Processing and Methods of Making Elastic Film Composition

Preparation of polymer compounds of the disclosed invention is uncomplicated once the proper ingredients have been selected. The compound can be made in batch or continuous operations.

Mixing in a continuous process typically occurs in an extruder that is elevated to a temperature that is sufficient to melt the polymer matrix with addition of all additives at the feed-throat, or by injection or side-feeders downstream. Extruder speeds can range from about 200 to about 700 revolutions per minute (rpm), for example, from about 250 rpm to about 350 rpm. Typically, the output from the extruder is pelletized for later processing into thermoplastic articles.

Processing techniques are described in available references, for example, Dominick V. Rosato et al., Plastics Design Handbook (Springer 2013).

In some embodiments, thermoplastic elastomer compounds of the disclosed invention are molded by injection molding processes into thermoplastic articles.

Further aspects of the invention are directed to calendared articles made by calendaring processes.

### Usefulness of the Invention

The composition of the disclosed invention can be useful for making any type of fabric application including those that requires resistant to staining and damaging from food, drinks, oil, dirt, cleaners, and other related items.

The calendared composition of the disclosed invention have potential for use in applications in many different industries, including but not limited to: home decor; furniture; apparel and footwear; automotive and transportation; consumer products; electronics; healthcare and medical; household; and other industries or applications benefiting from the unique combination of properties.

In some embodiments, the composition of the present invention can be especially useful for making drapery, furniture, fabric covering for automobile seats, as well as clothing and footwear.

### EXAMPLES

Non-limiting examples of various embodiments of the disclosed invention are provided.

TABLE 1
Formulation of Examples

| | | Example A | | | Example B | | | Example C | | |
|---|---|---|---|---|---|---|---|---|---|---|
| Raw Material | Density | pphr | Density | % | pphr | Density | % | pphr | Density | % |
| Kraton G1650 | 0.94 | 31.69 | 33.71 | 31.94 | 31.69 | 33.71 | 31.69 | 37.69 | 40.10 | 37.69 |
| Kraton FG1901X- | 0.90 | 11.52 | 12.80 | 11.61 | 11.52 | 12.80 | 11.52 | 0.00 | 0.00 | 0.00 |
| 1000-05 | | | | | | | | | | |
| 100 viscosity | 1.04 | 31.69 | 30.47 | 31.94 | 0.00 | 0.00 | 0.00 | 0.00 | 0.00 | 0.00 |
| USP white oil | | | | | | | | | | |
| Dowlex 2035 NT | 2.71 | 8.64 | 3.19 | 8.71 | 0.00 | 0.00 | 0.00 | 0.00 | 0.00 | 0.00 |
| Plastolyn 290 | 0.50 | 8.64 | 17.28 | 8.71 | 8.64 | 17.28 | 8.64 | 8.64 | 17.28 | 8.64 |
| Pinnacle 5112C3 | 1.03 | 4.03 | 3.91 | 4.06 | 0.00 | 0.00 | 0.00 | 0.00 | 0.00 | 0.00 |
| PC90083 | 1.03 | 2.02 | 1.96 | 2.04 | 2.02 | 1.96 | 2.02 | 2.02 | 1.96 | 2.02 |
| UV 62 Succinate | 0.88 | 0.40 | 0.45 | 0.40 | 0.40 | 0.45 | 0.40 | 0.40 | 0.45 | 0.40 |
| kemamide E Ultra | 0.94 | 0.23 | 0.24 | 0.23 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 | 0.12 | 0.24 | 0.12 |
| 380 viscosity white oil | 0.50 | 0.00 | 0.00 | 0.00 | 31.69 | 63.38 | 31.69 | 37.21 | 74.42 | 37.21 |
| Skypel G140D | 0.50 | 0.00 | 0.00 | 0.00 | 9.41 | 18.82 | 9.41 | 13.44 | 26.88 | 13.44 |
| Formolene 1102KR | 0.50 | 0.00 | 0.00 | 0.00 | 4.03 | 8.06 | 4.03 | 0.00 | 0.00 | 0.00 |

TABLE 2
Formulation of Examples

| | Example D | | | Example E | | | Example F | | |
|---|---|---|---|---|---|---|---|---|---|
| Raw Material | pphr | Density | % | pphr | Density | % | pphr | Density | % |
| Kraton G1650 | 32.69 | 34.78 | 32.69 | 31.69 | 33.71 | 31.69 | 32.69 | 34.78 | 32.69 |
| Kraton FG1901X- | 8.52 | 9.47 | 8.52 | 11.52 | 12.80 | 11.52 | 9.52 | 10.58 | 9.52 |
| 1000-05 | | | | | | | | | |
| 100 viscosity USP | 0.00 | 0.00 | 0.00 | 0.00 | 0.00 | 0.00 | 0.00 | 0.00 | 0.00 |
| white oil | | | | | | | | | |
| Dowlex 2035 NT | 0.00 | 0.00 | 0.00 | 0.00 | 0.00 | 0.00 | 0.00 | 0.00 | 0.00 |
| Plastolyn 290 | 8.64 | 17.28 | 8.64 | 8.64 | 17.28 | 8.64 | 8.64 | 17.28 | 8.64 |
| Pinnacle 5112C3 | 0.00 | 0.00 | 0.00 | 0.00 | 0.00 | 0.00 | 0.00 | 0.00 | 0.00 |
| PC90083 | 2.02 | 1.96 | 2.02 | 2.02 | 1.96 | 2.02 | 2.02 | 1.96 | 2.02 |
| UV 62 Succinate | 0.40 | 0.45 | 0.40 | 0.40 | 0.45 | 0.40 | 0.40 | 0.45 | 0.40 |
| kemamide E Ultra | 0.23 | 0.24 | 0.23 | 0.23 | 0.24 | 0.23 | 0.23 | 0.24 | 0.23 |
| Irgafos 168 | 0.13 | 0.26 | 0.13 | 0.13 | 0.26 | 0.13 | 0.13 | 0.26 | 0.13 |
| Kemamide U powder | 0.12 | 0.24 | 0.12 | 0.12 | 0.24 | 0.12 | 0.12 | 0.24 | 0.12 |
| Irganox 1010 | 0.12 | 0.24 | 0.12 | 0.12 | 0.24 | 0.12 | 0.12 | 0.24 | 0.12 |
| 380 viscosity white oil | 33.69 | 67.38 | 33.69 | 33.13 | 66.26 | 33.13 | 34.13 | 68.26 | 34.13 |
| Skypel G140D | 7.41 | 14.82 | 7.41 | 0.00 | 0.00 | 0.00 | 6.00 | 12.00 | 6.00 |
| Formolene 1102KR | 6.03 | 12.06 | 6.03 | 12.00 | 24.00 | 12.00 | 6.00 | 12.00 | 6.00 |

TABLE 3
Formulation of Examples

| | | Example AA | | | Example BA | | | Example CA | | | Example DA | | |
|---|---|---|---|---|---|---|---|---|---|---|---|---|---|
| Raw Material | Density | pphr | Density | % | pphr | Density | % | pphr | Density | % | pphr | Density | % |
| Piccolastic D-125 | 0.94 | 12.00 | 12.77 | 11.88 | 12.00 | 12.77 | 11.88 | 0.00 | 0.00 | 0.00 | 0.00 | 0.00 | 0.00 |
| Kraton G1652 | 0.90 | 24.00 | 26.67 | 23.76 | 20.00 | 22.22 | 19.80 | 0.00 | 0.00 | 0.00 | 0.00 | 0.00 | 0.00 |
| Kraton G1650 | 1.04 | 34.00 | 32.69 | 33.66 | 36.00 | 34.62 | 35.64 | 57.00 | 54.81 | 56.44 | 55.00 | 52.88 | 54.46 |
| 380 Oil | 2.71 | 28.00 | 10.33 | 27.72 | 30.00 | 11.07 | 29.70 | 29.00 | 10.70 | 28.71 | 31.00 | 11.44 | 30.69 |
| Polystyrene MB3150 | 0.50 | 0.00 | 0.00 | 0.00 | 0.00 | 0.00 | 0.00 | 12.00 | 24.00 | 11.88 | 12.00 | 24.00 | 11.88 |
| Regalrez 1126 | 1.03 | 0.00 | 0.00 | 0.00 | 0.00 | 0.00 | 0.00 | 0.00 | 0.00 | 0.00 | 0.00 | 0.00 | 0.00 |
| PC90083 | 1.03 | 2.00 | 1.94 | 1.98 | 2.00 | 1.94 | 1.98 | 2.00 | 1.94 | 1.98 | 2.00 | 1.94 | 1.98 |
| UV 62 Succinate | 0.88 | 0.40 | 0.45 | 0.40 | 0.40 | 0.45 | 0.40 | 0.40 | 0.45 | 0.40 | 0.40 | 0.45 | 0.40 |
| kemamide E Ultra | 0.94 | 0.23 | 0.24 | 0.23 | 0.23 | 0.24 | 0.23 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 | 0.12 | 0.24 | 0.12 | 0.12 | 0.24 | 0.12 |
| Kraton G1657 | 0.50 | 0.00 | 0.00 | 0.00 | 0.00 | 0.00 | 0.00 | 0.00 | 0.00 | 0.00 | 0.00 | 0.00 | 0.00 |
| Epolene C10 | 0.50 | 0.00 | 0.00 | 0.00 | 0.00 | 0.00 | 0.00 | 0.00 | 0.00 | 0.00 | 0.00 | 0.00 | 0.00 |

TABLE 4
Formulation of Examples

| | Example EA | | | Example FA | | | Example GA | | |
|---|---|---|---|---|---|---|---|---|---|
| Raw Material | pphr | Density | % | pphr | Density | % | pphr | Density | % |
| Piccolastic D-125 | 0.00 | 0.00 | 0.00 | 0.00 | 0.00 | 0.00 | 10.00 | 10.64 | 10.00 |
| Kraton G1652 | 0.00 | 0.00 | 0.00 | 0.00 | 0.00 | 0.00 | 0.00 | 0.00 | 0.00 |
| Kraton G1650 | 0.00 | 0.00 | 0.00 | 0.00 | 0.00 | 0.00 | 0.00 | 0.00 | 0.00 |
| 380 Oil | 0.00 | 0.00 | 0.00 | 4.00 | 1.48 | 4.00 | 7.00 | 2.58 | 7.00 |
| Polystyrene MB3150 | 0.00 | 0.00 | 0.00 | 0.00 | 0.00 | 0.00 | 0.00 | 0.00 | 0.00 |
| Regalrez 1126 | 20.00 | 19.42 | 19.80 | 20.00 | 19.42 | 20.00 | 18.00 | 17.48 | 18.00 |
| PC90083 (UV | 2.00 | 1.94 | 1.98 | 2.00 | 1.94 | 2.00 | 2.00 | 1.94 | 2.00 |
| stabilizer) | | | | | | | | | |
| UV 62 Succinate | 0.40 | 0.45 | 0.40 | 0.40 | 0.45 | 0.40 | 0.40 | 0.45 | 0.40 |
| kemamide E Ultra | 0.23 | 0.24 | 0.23 | 0.23 | 0.24 | 0.23 | 0.23 | 0.24 | 0.23 |
| Irgafos 168 | 0.13 | 0.26 | 0.13 | 0.13 | 0.26 | 0.13 | 0.13 | 0.26 | 0.13 |
| Kemamide U powder | 0.12 | 0.24 | 0.12 | 0.12 | 0.24 | 0.12 | 0.12 | 0.24 | 0.12 |
| Irganox 1010 | 0.12 | 0.24 | 0.12 | 0.12 | 0.24 | 0.12 | 0.12 | 0.24 | 0.12 |
| Kraton G1657 | 66.00 | 132.00 | 65.35 | 63.00 | 126.00 | 63.00 | 62.00 | 124.00 | 62.00 |
| Epolene C10 | 12.00 | 24.00 | 11.88 | 10.00 | 20.00 | 10.00 | 0.00 | 0.00 | 0.00 |

TABLE 5
Formulations of Examples

| | | Example AB | | | Example BB | | | Example CB | | | Example DB | | |
|---|---|---|---|---|---|---|---|---|---|---|---|---|---|
| Raw Material | Density | pphr | Density | % | pphr | Density | % | pphr | Density | % | pphr | Density | % |
| Kraton G1650 | 0.94 | 31.69 | 33.71 | 31.90 | 25.00 | 26.60 | 25.17 | 27.00 | 28.72 | 27.18 | 27.00 | 28.72 | 27.18 |
| Kraton FG1901X- | 0.90 | 11.52 | 12.80 | 11.60 | 7.00 | 7.78 | 7.05 | 7.00 | 7.78 | 7.05 | 7.00 | 7.78 | 7.05 |
| 1000-05 | | | | | | | | | | | | | |
| 100 viscosity | 1.04 | 31.69 | 30.47 | 31.90 | 0.00 | 0.00 | 0.00 | 0.00 | 0.00 | 0.00 | 0.00 | 0.00 | 0.00 |
| USP white oil | | | | | | | | | | | | | |
| Dowlex 2035 NT | 2.71 | 8.64 | 3.19 | 8.70 | 7.14 | 2.63 | 7.19 | 7.14 | 2.63 | 7.19 | 7.14 | 2.63 | 7.19 |
| Plastolyn 290 | 0.50 | 8.64 | 17.28 | 8.70 | 8.64 | 17.28 | 8.70 | 0.00 | 0.00 | 0.00 | 0.00 | 0.00 | 0.00 |
| Pinnacle 5112C3 | 1.03 | 4.03 | 3.91 | 4.06 | 3.50 | 3.40 | 3.52 | 3.50 | 3.40 | 3.52 | 3.50 | 3.40 | 3.52 |
| PC90083 | 1.03 | 2.02 | 1.96 | 2.03 | 2.02 | 1.96 | 2.03 | 2.02 | 1.96 | 2.03 | 2.02 | 1.96 | 2.03 |
| UV 62 Succinate | 0.88 | 0.50 | 0.57 | 0.50 | 0.50 | 0.57 | 0.50 | 0.50 | 0.57 | 0.50 | 0.50 | 0.57 | 0.50 |
| kemamide E Ultra | 0.94 | 0.23 | 0.24 | 0.23 | 0.23 | 0.24 | 0.23 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 | 0.12 | 0.24 | 0.12 | 0.12 | 0.24 | 0.12 |
| Polystyrene MB3150 | 0.50 | 0.00 | 0.00 | 0.00 | 0.00 | 0.00 | 0.00 | 0.00 | 0.00 | 0.00 | 9.00 | 18.00 | 9.06 |
| Kraton G1652 | 0.50 | 0.00 | 0.00 | 0.00 | 13.24 | 26.48 | 13.33 | 10.88 | 21.76 | 10.95 | 10.88 | 21.76 | 10.95 |
| Drakeol 34 | 0.50 | 0.00 | 0.00 | 0.00 | 31.69 | 63.38 | 31.90 | 31.69 | 63.38 | 31.90 | 31.69 | 63.38 | 31.90 |
| Piccolastic D125 | 0.50 | 0.00 | 0.00 | 0.00 | 0.00 | 0.00 | 0.00 | 9.00 | 18.00 | 9.06 | 0.00 | 0.00 | 0.00 |

TABLE 6
Formulations of Examples

| | Example EB | | | Example FB | | | Example GB | | |
|---|---|---|---|---|---|---|---|---|---|
| Raw Material | pphr | Density | % | pphr | Density | % | pphr | Density | % |
| Kraton G1650 | 31.69 | 33.71 | 31.90 | 31.69 | 33.71 | 31.90 | 31.69 | 33.71 | 31.90 |
| Kraton FG1901X-1000-05 | 0.00 | 0.00 | 0.00 | 11.52 | 12.80 | 11.60 | 0.00 | 0.00 | 0.00 |
| 100 viscosity USP white oil | 0.00 | 0.00 | 0.00 | 0.00 | 0.00 | 0.00 | 0.00 | 0.00 | 0.00 |
| Dowlex 2035 NT | 8.64 | 3.19 | 8.70 | 12.00 | 4.43 | 12.08 | 11.00 | 4.06 | 11.07 |
| Plastolyn 290 | 9.00 | 18.00 | 9.06 | 9.31 | 18.62 | 9.37 | 0.00 | 0.00 | 0.00 |
| Pinnacle 5112C3 | 3.67 | 3.56 | 3.69 | 0.00 | 0.00 | 0.00 | 0.00 | 0.00 | 0.00 |
| PC90083 | 2.02 | 1.96 | 2.03 | 2.02 | 1.96 | 2.03 | 2.02 | 1.96 | 2.03 |
| UV 62 Succinate | 0.50 | 0.57 | 0.50 | 0.50 | 0.57 | 0.50 | 0.50 | 0.57 | 0.50 |
| kemamide E Ultra | 0.23 | 0.24 | 0.23 | 0.23 | 0.24 | 0.23 | 0.23 | 0.24 | 0.23 |
| Irgafos 168 | 0.13 | 0.26 | 0.13 | 0.13 | 0.26 | 0.13 | 0.13 | 0.26 | 0.13 |
| Kemamide U powder | 0.12 | 0.24 | 0.12 | 0.12 | 0.24 | 0.12 | 0.12 | 0.24 | 0.12 |
| Irganox 1010 | 0.12 | 0.24 | 0.12 | 0.12 | 0.24 | 0.12 | 0.12 | 0.24 | 0.12 |
| Polystyrene MB3150 | 0.00 | 0.00 | 0.00 | 0.00 | 0.00 | 0.00 | 0.00 | 0.00 | 0.00 |
| Kraton G1652 | 11.52 | 23.04 | 11.60 | 0.00 | 0.00 | 0.00 | 11.52 | 23.04 | 11.60 |
| Drakeol 34 | 31.69 | 63.38 | 31.90 | 31.69 | 63.38 | 31.90 | 31.69 | 63.38 | 31.90 |
| Piccolastic D125 | 0.00 | 0.00 | 0.00 | 0.00 | 0.00 | 0.00 | 10.31 | 20.62 | 10.38 |

TABLE 7
Formulations of Examples

| | | Example AC | | | Example BC | | | Example CC | | | Example DC | | |
|---|---|---|---|---|---|---|---|---|---|---|---|---|---|
| Raw Material | Density | pphr | Density | % | pphr | Density | % | pphr | Density | % | pphr | Density | % |
| Piccolastic D-125 | 0.94 | 6.00 | 6.38 | 6.00 | 4.50 | 4.79 | 4.50 | 0.00 | 0.00 | 0.00 | 0.00 | 0.00 | 0.00 |
| Kraton G1652 | 0.90 | 12.00 | 13.33 | 12.00 | 12.00 | 13.33 | 12.00 | 0.00 | 0.00 | 0.00 | 0.00 | 0.00 | 0.00 |
| Kraton G1650 | 1.04 | 44.50 | 42.79 | 44.50 | 44.50 | 42.79 | 44.50 | 46.50 | 44.71 | 46.50 | 46.50 | 44.71 | 46.50 |
| 380 Oil | 2.71 | 28.50 | 10.52 | 28.50 | 28.50 | 10.52 | 28.50 | 21.50 | 7.93 | 21.50 | 21.50 | 7.93 | 21.50 |
| Polystyrene MB3150 | 0.50 | 6.00 | 12.00 | 6.00 | 4.50 | 9.00 | 4.50 | 6.00 | 12.00 | 6.00 | 4.50 | 9.00 | 4.50 |
| PC90083 | 1.03 | 2.00 | 1.94 | 2.00 | 2.00 | 1.94 | 2.00 | 2.00 | 1.94 | 2.00 | 2.00 | 1.94 | 2.00 |
| UV 62 Succinate | 0.88 | 0.40 | 0.45 | 0.40 | 0.40 | 0.45 | 0.40 | 0.40 | 0.45 | 0.40 | 0.40 | 0.45 | 0.40 |
| kemamide E Ultra | 0.94 | 0.23 | 0.24 | 0.23 | 0.23 | 0.24 | 0.23 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 | 0.12 | 0.24 | 0.12 | 0.12 | 0.24 | 0.12 |
| Dowlex 2035 | 0.50 | 0.00 | 0.00 | 0.00 | 3.00 | 6.00 | 3.00 | 0.00 | 0.00 | 0.00 | 3.00 | 6.00 | 3.00 |
| Polyethylene | | | | | | | | | | | | | |
| Polystyrene EA3400 | 0.50 | 0.00 | 0.00 | 0.00 | 0.00 | 0.00 | 0.00 | 4.60 | 9.20 | 4.60 | 3.10 | 6.20 | 3.10 |
| Kraton A1536 | 0.50 | 0.00 | 0.00 | 0.00 | 0.00 | 0.00 | 0.00 | 18.40 | 36.80 | 18.40 | 18.40 | 36.80 | 18.40 |

TABLE 8
Formulations of Examples

| | Example EC | | | Example FC | | | Example GC | | |
|---|---|---|---|---|---|---|---|---|---|
| Raw Material | pphr | Density | % | pphr | Density | % | pphr | Density | % |
| Piccolastic D-125 | 6.00 | 6.38 | 6.00 | 4.50 | 4.79 | 4.50 | 4.00 | 4.26 | 4.00 |
| Kraton G1652 | 11.00 | 12.22 | 11.00 | 11.00 | 12.22 | 11.00 | 8.00 | 8.89 | 8.00 |
| Kraton G1650 | 36.00 | 34.62 | 36.00 | 36.00 | 34.62 | 36.00 | 42.00 | 40.38 | 42.00 |
| 380 Oil | 21.00 | 7.75 | 21.00 | 21.00 | 7.75 | 21.00 | 24.00 | 8.86 | 24.00 |
| Polystyrene MB3150 | 0.00 | 0.00 | 0.00 | 0.00 | 0.00 | 0.00 | 4.00 | 8.00 | 4.00 |
| PC90083 | 2.00 | 1.94 | 2.00 | 2.00 | 1.94 | 2.00 | 2.00 | 1.94 | 2.00 |
| UV 62 Succinate | 0.40 | 0.45 | 0.40 | 0.40 | 0.45 | 0.40 | 0.40 | 0.45 | 0.40 |
| kemamide E Ultra | 0.23 | 0.24 | 0.23 | 0.23 | 0.24 | 0.23 | 0.23 | 0.24 | 0.23 |
| Irgafos 168 | 0.13 | 0.26 | 0.13 | 0.13 | 0.26 | 0.13 | 0.13 | 0.26 | 0.13 |
| Kemamide U powder | 0.12 | 0.24 | 0.12 | 0.12 | 0.24 | 0.12 | 0.12 | 0.24 | 0.12 |
| Irganox 1010 | 0.12 | 0.24 | 0.12 | 0.12 | 0.24 | 0.12 | 0.12 | 0.24 | 0.12 |
| Dowlex 2035 Polyethylene | 0.00 | 0.00 | 0.00 | 3.00 | 6.00 | 3.00 | 0.00 | 0.00 | 0.00 |
| Polystyrene EA3400 | 4.60 | 9.20 | 4.60 | 3.10 | 6.20 | 3.10 | 3.00 | 6.00 | 3.00 |
| Kraton A1536 | 18.40 | 36.80 | 18.40 | 18.40 | 36.80 | 18.40 | 12.00 | 24.00 | 12.00 |

TABLE 9
Formulations of Examples

| | | Example AD | | |
|---|---|---|---|---|
| Raw Material | Density | PHR | Density | % |
| Piccolastic D-125 | 0.94 | 12.00 | 12.77 | 11.88 |
| Kraton G1652 | 0.90 | 0.00 | 0.00 | 0.00 |
| Kraton G1650 | 1.04 | 34.00 | 32.69 | 33.66 |
| 380 Oil | 2.71 | 32.00 | 11.81 | 31.68 |
| Polystyrene MB3150 | 0.50 | 0.00 | 0.00 | 0.00 |
| Regalrez 1126 | 1.03 | 0.00 | 0.00 | 0.00 |
| PC90083 | 1.03 | 2.00 | 1.94 | 1.98 |
| UV 62 Succinate | 0.88 | 0.40 | 0.45 | 0.40 |
| kemamide E Ultra | 0.94 | 0.23 | 0.24 | 0.23 |
| Irgafos 168 | 0.50 | 0.13 | 0.26 | 0.13 |
| Kemamide U powder | 0.50 | 0.12 | 0.24 | 0.12 |
| Irganox 1010 | 0.50 | 0.12 | 0.24 | 0.12 |
| Kraton G1657 | 0.50 | 20.00 | 40.00 | 19.80 |
| Epolene C10 | 0.50 | 0.00 | 0.00 | 0.00 |
| Polystyrene EA3400 | 0.50 | 0.00 | 0.00 | 0.00 |
| Kraton A1536H | 0.50 | 0.00 | 0.00 | 0.00 |
| Affinity GA 1900 | 0.50 | 0.00 | 0.00 | 0.00 |

TABLE 10
Formulations of Examples

| | | Example AE | | | Example BE | | |
|---|---|---|---|---|---|---|---|
| Raw Material | Density | PHR | Density | % | pphr | Density | % |
| Piccolastic D-125 | 0.94 | 0.00 | 0.00 | 0.00 | 0.00 | 0.00 | 0.00 |
| Kraton G1652 | 0.90 | 0.00 | 0.00 | 0.00 | 0.00 | 0.00 | 0.00 |
| Kraton G1650 | 1.04 | 32.00 | 30.77 | 31.68 | 32.00 | 30.77 | 31.68 |
| 380 Oil | 2.71 | 24.80 | 9.15 | 24.55 | 24.80 | 9.15 | 24.55 |
| Polystyrene MB3150 | 0.50 | 0.00 | 0.00 | 0.00 | 0.00 | 0.00 | 0.00 |
| Regalrez 1126 | 1.03 | 0.00 | 0.00 | 0.00 | 0.00 | 0.00 | 0.00 |
| PC90083 | 1.03 | 2.00 | 1.94 | 1.98 | 2.00 | 1.94 | 1.98 |
| UV 62 Succinate | 0.88 | 0.40 | 0.45 | 0.40 | 0.40 | 0.45 | 0.40 |
| kemamide E Ultra | 0.94 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 |
| Kraton G1657 | 0.50 | 0.00 | 0.00 | 0.00 | 0.00 | 0.00 | 0.00 |
| Epolene C10 | 0.50 | 0.00 | 0.00 | 0.00 | 0.00 | 0.00 | 0.00 |
| Polystyrene EA3400 | 0.50 | 9.20 | 18.40 | 9.11 | 9.20 | 18.40 | 9.11 |
| Kraton A1536H | 0.50 | 32.00 | 64.00 | 31.68 | 32.00 | 64.00 | 31.68 |
| Affinity GA 1900 | 0.50 | 0.00 | 0.00 | 0.00 | 0.00 | 0.00 | 0.00 |

TABLE 11
Formulations of Examples

| | | Example AF | | | Example BF | | |
|---|---|---|---|---|---|---|---|
| Raw Material | Density | pphr | Density | % | pphr | Density | % |
| Piccolastic D-125 | 0.94 | 0.00 | 0.00 | 0.00 | 0.00 | 0.00 | 0.00 |
| Kraton G1652 | 0.90 | 20.00 | 22.22 | 19.80 | 20.00 | 22.22 | 19.80 |
| Kraton G1650 | 1.04 | 24.00 | 23.08 | 23.76 | 24.00 | 23.08 | 23.76 |
| 380 Oil | 2.71 | 24.80 | 9.15 | 24.55 | 24.80 | 9.15 | 24.55 |
| Polystyrene MB3150 | 0.50 | 9.20 | 18.40 | 9.11 | 9.20 | 18.40 | 9.11 |
| Regalrez 1126 | 1.03 | 0.00 | 0.00 | 0.00 | 0.00 | 0.00 | 0.00 |
| PC90083 (UV stabilizer) | 1.03 | 2.00 | 1.94 | 1.98 | 2.00 | 1.94 | 1.98 |
| UV 62 Succinate | 0.88 | 0.40 | 0.45 | 0.40 | 0.40 | 0.45 | 0.40 |
| kemamide E Ultra | 0.94 | 0.23 | 0.24 | 0.23 | 0.23 | 0.24 | 0.23 |
| Irgafos 168 | 0.50 | 0.13 | 0.26 | 0.13 | 0.13 | 0.26 | 0.13 |
| Kemamide U powder | 0.50 | 0.12 | 0.24 | 0.12 | 0.12 | 0.24 | 0.12 |
| Irganox 1010 | 0.50 | 0.12 | 0.24 | 0.12 | 0.12 | 0.24 | 0.12 |
| Kraton G1657 | 0.50 | 0.00 | 0.00 | 0.00 | 0.00 | 0.00 | 0.00 |
| Epolene C10 | 0.50 | 0.00 | 0.00 | 0.00 | 0.00 | 0.00 | 0.00 |
| Polystyrene EA3400 | 0.50 | 0.00 | 0.00 | 0.00 | 0.00 | 0.00 | 0.00 |
| Kraton A1536H | 0.50 | 20.00 | 40.00 | 19.80 | 20.00 | 40.00 | 19.80 |
| Affinity GA 1900 | 0.50 | 0.00 | 0.00 | 0.00 | 0.00 | 0.00 | 0.00 |

TABLE 12
Formulations of Examples

| | | Example AG | | |
|---|---|---|---|---|
| Raw Material | Density | PHR | Density | % |
| Piccolastic D-125 | 0.94 | 6.00 | 6.38 | 6.00 |
| Kraton G1652 | 0.90 | 12.00 | 13.33 | 12.00 |
| Kraton G1650 | 1.04 | 44.50 | 42.79 | 44.50 |
| 380 Oil | 2.71 | 28.50 | 10.52 | 28.50 |
| Polystyrene MB3150 | 0.50 | 6.00 | 12.00 | 6.00 |
| PC90083 (UV stabilizer) | 1.03 | 2.00 | 1.94 | 2.00 |
| UV 62 Succinate | 0.88 | 0.40 | 0.45 | 0.40 |
| kemamide E Ultra | 0.94 | 0.23 | 0.24 | 0.23 |
| Irgafos 168 | 0.50 | 0.13 | 0.26 | 0.13 |
| Kemamide U powder | 0.50 | 0.12 | 0.24 | 0.12 |
| Irganox 1010 | 0.50 | 0.12 | 0.24 | 0.12 |
| Dowlex 2035 Polyethylene | 0.50 | 0.00 | 0.00 | 0.00 |
| Polystyrene EA3400 | 0.50 | 0.00 | 0.00 | 0.00 |
| Kraton A1536 | 0.50 | 0.00 | 0.00 | 0.00 |

TABLE 13
Ingredients

| Raw Material | Type of Ingrdient |
|---|---|
| 100 viscosity USP white | Oil |
| oil | |
| 380 viscosity white oil | Oil |
| Dowlex 2035 NT | polyethylene resin |
| Drakeol 34 | mineral oil |
| Epolene C10 | low density polyethylene |
| | homopolymer |
| Formolene 1102KR | polypropylene homopolymer |
| Irgafos 168 | processing aid |
| Irganox 1010 | stabilizer |
| kemamide E Ultra | lubricant |
| Kemamide U powder | lubricant |
| Kraton A1536 | SEBS polymer |
| Kraton FG1901X-1000-05 | SEBS polymer |
| Kraton G1650 | SEBS polymer |
| Kraton G1652 | SEBS polymer |
| Kraton G1657 | SEBS polymer |
| PC90083 | UV stabilizer |
| Piccolastic D-125 | hydrocarbon resin |
| Pinnacle 5112C3 | polypropylene copolymer |
| Plastolyn 290 | hydrocarbon resin |
| Polystyrene EA3400 | polystyrene |
| Polystyrene MB3150 | polystyrene |
| Regalrez 1126 | hydrocarbon resin |
| Skypel G140D | thermoplastic polyester elastomer |
| UV 62 Succinate | UV absorber |

TABLE 14
Peel Test Results

| | Did film | | | |
|---|---|---|---|---|
| | separate from | Melt Index | Melt Index | Avg. Peel |
| | plate while | 190 C. | 230 C. | force (Lbf |
| | bonding with | grams/ | grams/ | of film at |
| Sample # | fabric? | 10 mins | 10 mins | room temp) |
| Example AA | Y | 2.52 | 20.64 | 1.5 |
| Example BA | Y | 2.94 | 24.84 | 1.7 |
| Example CA | Y | 0.66 | 6.42 | 2 |
| Example DA | Y | 0.96 | 8.46 | 2 |
| Example BA | Y | 2.52 | 22.08 | 1.5 |
| Example AC | Y | 1.02 | 9.6 | 1.2 |
| Example DC | Y | 0.42 | 3.36 | 3 |
| Example FC | Y | 0.48 | 5.1 | 3 |
| Example AD | Y | 4.98 | 38.28 | 2 |
| Example AE | Y | 1.08 | 8.04 | 3 |
| Example AF | Y | 1.14 | 10.92 | 2 |
| Example AG | Y | 1.32 | 12.24 | 0.5 |
| Example B | N | 11.58 | 80.7 | 15.5 |
| Example E | N | 8.34 | 54.06 | 6 |
| Example EA | N | 12.18 | 56.76 | 15.8 |
| Example FA | N | 18.6 | 90.64 | 7.5 |
| Example GA | N | 16.74 | 74.1 | 7.4 |
| Example BC | N | 6.78 | 46.62 | 16.1 |
| Example EC | N | 6.84 | 46.5 | 20.5 |
| Example FC | N | 4.62 | 38.58 | 10.4 |
| Example GC | N | 5.52 | 29.1 | 3 |

TABLE 15
Shore A Hardness

| Example | Shore A Hardness |
|---|---|
| A | 57 |
| B | 55 |
| C | 47 |
| D | 54 |
| E | 64 |
| F | 54 |
| AA | 48 |
| BA | 46 |
| CA | 58 |
| DA | 56 |
| EA | 46 |
| FA | 42 |
| GA | 37 |
| GB | 51.67 |
| AC | 49.37 |
| BC | 49.1 |
| CC | 57.45 |
| DC | 56.22 |
| EC | 52.92 |
| FC | 53.77 |
| GC | 53.9 |
| AD | 34 |
| AE | 48.56 |
| BE | 48.56 |
| AF | 50 |
| CF | 50 |
| AG | 49.37 |

Without undue experimentation, those having ordinary skill in the art can utilize the written description, including the Examples, to make and use aspects of the disclosed invention.

All documents cited in the Embodiments of the Invention are incorporated herein by reference in their entirety unless otherwise specified. The citation of any document is not to be construed as an admission that it is prior art with respect to the disclosed invention.

While particular embodiments of the disclosed invention have been illustrated and described, it would be obvious to those skilled in the art that various other changes and modifications can be made without departing from the spirit and scope of the invention. The appended claims are intended to cover all such changes and modifications within the scope of the disclosed invention.

1. A composition for calendaring, comprising:
(a) an elastic film comprising:
a styrenic block copolymer;
an oil; and
optional additives;
(b) a fabric;
wherein the elastic film is positioned adjacent to the fabric.

2. The composition of claim 1, wherein the styrenic block copolymer is selected from a group consisting of styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, or combinations thereof.

3. The composition of claim 1, wherein the fabric is selected from the group consisting of cotton, polyester, or combinations thereof.

4. The composition of claim 1, wherein the elastic film further comprises greater than or equal to 25 wt. % and less than or equal to 75 wt. % styrenic block copolymer.

5. The composition of claim 1, wherein the elastic film further comprises greater than or equal to 40 wt. % and less than or equal to 70 wt. % styrenic block copolymer.

6. The composition of claim 1, wherein the elastic film further comprises greater than or equal to 20 wt. % and less than or equal to 35 wt. % oil.

7. The composition of claim 1, wherein the elastic film further comprises greater than or equal to 25 wt. % and less than or equal to 30 wt. % oil.

8. The composition of claim 1, wherein the elastic film is positioned between and adjacent to a first fabric and a second fabric.

9. The composition of claim 8, wherein the first fabric comprises a first material and the second fabric comprises a second material.

10. The composition of claim 9, wherein the first material is the same as the second material.

11. The composition of claim 9, wherein the first material is different than the second material.

12. The composition of claim 1, wherein the melt indices of the elastic film at 190° C. is below 4 grams/10 minutes.

13. The composition of claim 1, wherein the melt indices of the elastic film at 230° C. is approximately between 35-39 grams/10 minutes.

14. The composition of claim 1, wherein the peel force for the elastic film from stainless steel plates at room temperature is approximately between 0-3 lbf.

15. An article comprising the composition of claim 1, wherein the article is selected from the group consisting of apparel, footwear, furniture, and drapery.

16. A method for manufacturing a composition comprising the steps of:
preparing an elastic film composition comprising a styrenic block copolymer, an oil, and optional additives, wherein the elastic film has a first side and an opposite second side;
sandwiching the elastic film composition between a first stainless steel plate on the first side and fabric on the second side to create a layered assembly;
pre-heating the layered assembly;
pressing the layered assembly between the first stainless steel plate and a second stainless steel plate; and
removing the fabric and elastic film assembly from the stainless steel plate.
